(19) United States
(12) Patent Application Publication
(10) Pub. No.: US 2020/0196524 A1
(43) Pub. Date: Jun. 25, 2020

(54) CUTTING DEVICE FOR COMMINUTING CROP RESIDUES OR PLANT PARTS

(71) Applicant: Konrad Hendlmeier, Untersanding (DE)

(72) Inventor: Konrad Hendlmeier, Untersanding (DE)

(21) Appl. No.: 16/720,826

(22) Filed: Dec. 19, 2019

(30) Foreign Application Priority Data
Dec. 21, 2018 (DE) 10 2018 133 505.9

(51) Int. Cl. A01D 34/835; A01F 12/40; A01F 29/02

(52) U.S. Cl. CPC A01D 34/8355; A01F 29/02; A01F 12/40

(57) ABSTRACT

A cutting device for comminuting crop residues or catch crops on agricultural land is described. The cutting device is designed to be rotatable around a center longitudinal axis (MLA) and, to this, it has at least one bearing unit for rotatably mounting. The cutting device includes first and second respectively elongated cutting blade element, as well as at least one holding means for holding the cutting blade elements. The elongated cutting blade elements each comprise a cutting edge section and a connecting section lying opposite to the cutting edge section and are radially orientated in such a way that the cutting edge sections of the elongated cutting edge sections are arranged at a radial distance from the center longitudinal axis. The cutting blade elements are directly connected to each other with the aid of the holding means, wherein the connecting sections of the cutting blade elements are arranged directly adjoining one another in a center region of the cutting device receiving the center longitudinal axis (MLA).

### BACKGROUND OF THE INVENTION

### Technical Field

The invention relates to a cutting device for comminuting crop residues or catch crops on agricultural land.

### Background Art

Cutting or blade rollers for comminuting plant parts are well known from prior art. In particular, such rotating cutting or blade rollers are used in soil cultivating apparatuses and are intended for comminuting crop residues, existing vegetation on agricultural land, or other plants or plant parts.

A cutting apparatus in the form of such a rotating cutting roller is known from German Patent No. DE 202014104667 U1, for example. The cutting roller described therein has a roller body, on the roller body surface of which the cutting elements are arranged, and these being diagonal to the operating direction of the cutting apparatus or to the axis of rotation of the cutting roller. Unfavourably, in the case of such cutting apparatus, this can result in the cutting roller becoming clogged with plant material or crops due to the arrangement of the cutting elements on the roller body surface and due to the small distance between the blade of the cutting elements and the roller body surface. Also, lumps can settle between cutting elements running diagonally to one another, thereby impairing the cutting effect.

Furthermore, from the prior art, rotating cutting or blade rollers are known where a multitude of cutting or blade elements are attached essentially parallel to the axis of rotation on the surface of a roller body or on the outer shell surface of a hollow shaft body. For example, PCT Published Application No. WO 2014/079449 A1 discloses such a blade roller.

German Patent No. DE202015101330 U1 also provides a soil cultivation device with a rotatably mounted cutting roller where the cutting roller is equipped with a multitude of cutting blade elements, the cutting sections of which run parallel to the axis of rotation of the cutting roller.

With the soil tillage/cultivation apparatuses described above however, it is difficult to cut the plant parts very short, meaning to cut them into short lengths, and to simultaneously prevent a detrimental clogging of the cutting blade elements.

In agriculture, however, it is increasingly being demanded that plant parts be, in particular, cut into short lengths. For example, for ecologization of agriculture, special ecological land-use programs are supported, which are known under the key word ‘greening’. Among other things, within such ‘greening’ programs, vegetation, winter crops and winter catch crops shall be comminuted and incorporated into the soil only directly before the new seeding of the agricultural land in spring. Since the policy of minimizing the use of ploughs and promoting ploughless soil tillage is also the motto within the scope of ecologization of agriculture, the plants or plant parts must be comminuted in such a way that rapid decomposition can also take place on or near the soil surface, even if the comminuted plant material is not buried deep into the soil. Thereby, a particularly reliable cutting effect of the cutting apparatuses of the soil tillage units is gaining increasing importance, that being with reference to a wide variety of catch crops and vegetation.

Also with regard to crop residues, in particular, stubbles or maize stalks, the very finest comminution possible is of enormous importance since the conversion of the comminuted material is more successful and quicker, for example, due to earthworms, soil animals, and microorganisms, the finer the crop residues are comminuted. The microbiological activities and the rotting can be significantly accelerated due to this. Scientific studies show that, for example, worms in the soil and microorganisms require that the comminuted material be broken up into short components that are lying on the ground to enable conversion of the organic material. In turn, due to this rapid decomposition, pest infection cycles can be interrupted. For example, the spreading and propagation of the European corn borer can be countered by means of this.

Experts are therefore now demanding that all organic plant parts, in particular, also crop residues, such as stubbles or maize stalks, should be cut to a specific length, or cut to a maximum length of 15 to 17 cm, in order to promote the decomposition or rotting, and to prevent excessive propagation of plant pests, such as the now very widespread European corn borer.

With the solutions known from prior art, it is difficult to finely comminute the plant parts and simultaneously prevent a detrimental clogging of the cutting blade elements so that a correspondingly desired cutting performance and cutting quality can only be achieved with a high level of energy expenditure. Therefore, despite the known solutions from prior art, there is a need for improved cutting devices for comminuting crop residues or catch crops on agricultural land.

### SUMMARY OF THE INVENTION

It is an object of the present invention to provide an improved cutting device that overcomes the disadvantages of prior art and reliably enables a short cutting length and fine comminution while preventing disturbing clogging.

The invention provides a cutting device for comminuting crop residues or catch crops on agricultural land, wherein the cutting device is designed to be rotatable around a center longitudinal axis and, to this, comprises at least one bearing unit for rotatable mounting. The cutting device comprises at least one of first and second respectively elongated cutting blade elements as well as at least one holding means for holding the cutting blade elements. The elongated cutting blade elements each comprise a cutting edge section and a connecting section lying opposite to the cutting edge section. The elongated cutting blade elements are radially orientated in such a way that the cutting edge sections are arranged at a radial distance from the center longitudinal axis. In particular, the invention is characterized in that the cutting blade elements are directly connected to each other with the aid of the holding means, wherein the connecting sections of the cutting blade elements are arranged directly adjoining one another in a center region of the cutting device receiving the center longitudinal axis.

The rotating cutting device, which is presently also designated as cutting apparatus, is also understood in the present case as a cutting roller arrangement or blade roller arrangement and can also be understood in the sense of the invention as a blade or cutting arrangement or as a blade or cutting tool. In particular, according to present understanding, the cutting device designed as a cutting roller arrangement is to be understood as a soil tillage tool or soil cultivation tool, or as a soil tillage/cultivation device or a soil tillage/cultivation apparatus. Thereby, in particular, the present cutting apparatus is designed to comminute a plant stock on an agricultural land, namely existing vegetation or, however, crop residues, such as stubbles for example, and that being in the region of the soil surface, thereby preferably also reaching into the soil directly under the soil surface. The cutting device is therefore provided, in particular, as a soil-tilling/cultivating apparatus for use in a soil tillage unit, i.e. the cutting and comminuting takes place in the form of a soil tillage/cultivation, in particular, also by means of at least surface penetration or “cutting” of the cutting blade elements into the ground or into the soil. Thereby, the cutting blade elements come into engagement with the ground surface with a free-end edge of the cutting edge sections.

The cutting device is used for cross-cutting of the plants or plant parts, meaning that the cutting direction runs transversely or essentially perpendicular to an operating direction of the cutting device or parallel to its center longitudinal axis, wherein, for cutting the plant parts, the cutting blade elements preferably penetrate into the ground or the soil in the application at hand. The cutting blade elements of the cutting device are designed as elongated flat material pieces with an essentially rectangular shape, whose cutting edge section extends longitudinally. Due to the radial orientation of the cutting blade elements, the cutting edge sections run essentially parallel to the center longitudinal axis so that, for example, when the cutting device rotates, the cutting edge section of each cutting blade element depicts a 360° angle at each rotation.

According to the invention, the cutting blade elements are directly connected to each other at their respective connecting sections and adjoin one another in the region of the center longitudinal axis, namely directly to each other in the center region of the cutting device. The present cutting device according to the invention thereby does not include a shaft or roller body and is therefore also to be understood as a shaftless cutting device or as a cutting device without a roller body. A shaft or roller body formed as a hollow shaft or roller cylinder is omitted in the cutting device according to the invention. In accordance with present understanding, the cutting device according to the invention therefore also represents a rotating blade arrangement.

Being particularly favorable, it is thereby possible to cut crop residues, such as stubbles or, in particular, maize stalks, to very short lengths, in particular to lengths of less than 170 mm or less than 150 mm, wherein, simultaneously, the clogging of the cutting device with plant material or soil is effectively prevented. Due to the favorable arrangement of the cutting blade elements, which are directly connected to each other, the number of cutting blade elements can be reduced and therefore an angular distance of adjacent cutting blade elements can be selected so that the intermediate space between the cutting blade elements is large enough to prevent clogging.

Due to the direct connection of the cutting blade elements, a total diameter of the cutting device is kept low, so that the desired short cutting length can be achieved even with a small number of cutting blade elements. For example, the total diameter of the cutting device is determined only by means of about twice the radial distance of the cutting edge section from the center longitudinal axis.

By comparison, the cutting apparatuses known from prior art have a total diameter that is calculated by adding the double radial distance of the cutting edge section from the surface of the roller body and the diameter of the roller body. With such enlarged diameters of the known cutting rollers from prior art, a multitude of cutting blade elements circumferentially arranged on the roller body surface are necessary in order to be able to generally achieve short cutting lengths. These cutting blade elements of the known cutting rollers are therefore arranged at smaller angular distances to each other in such a way that the risk of clogging with plant material and soil there is increased.

Favourably, this problem is solved in the case of the cutting device according to the invention. The small number of cutting blades possible in the case of the cutting device according to the invention also allows for rapid operation and high cutting performance in the case of a comparatively low level of energy expenditure.

The cutting blade elements are preferably arranged and aligned so that the cutting edge sections are orientated in such a way that a straight line depicting the center longitudinal axis of the cutting device and a straight line depicting an edge line or the free-end edge of the cutting edge sections run essentially parallel to one another. Being equally preferred, the cutting edge sections can be orientated in such a way that the two mentioned straight lines, namely the one along the center longitudinal axis and the one along the free-end edge run crookedly with one another. In the latter preferred embodiment, in the application state of the cutting device during soil tillage, namely in an operation of the cutting device rotating around the center longitudinal axis, in particular, it can be ensured that the free-end edge of a respective cutting blade element is only engaged with the soil surface in sections. This means, in the case of a certain defined rotational position, it is not the entire free-end edge, viewed across the entire longitudinal extension, which is engaged with the soil surface.

In accordance with a preferred embodiment, one or two or three or four further cutting blade elements are provided, wherein all cutting blade elements are directly adjoining one another in such a way that the respective connecting sections of the cutting blade elements directly connect to each other in the center region. In these preferred embodiments, therefore, three or four or five or six cutting blade elements are arranged radially around the center longitudinal axis. Thereby, the angular distance between adjacent cutting blade elements is always at least around 60° or more.

In particular, preferably, the cutting blade elements are arranged in a regularly distributed manner around the center longitudinal axis in such a way that the angular distances between adjacent cutting blade elements are respectively the same. Preferably, the respective connecting sections of the cutting blade elements thereby connect to each other at a predetermined angle.

In accordance with a preferred embodiment of the invention, a width of the cutting blade elements extending in the radial direction ranges from 50 mm to 150 mm, preferably from 60 mm to 140 mm, being particularly preferred from 70 mm to 130 mm, being especially particularly preferred from 75 mm to 125 mm, being particularly preferred from 85 mm to 115, even more preferably from 90 mm to 110 mm and, for example, at about 100 mm.

In particular, all cutting blade elements of the cutting device preferably have the same width. The width of the cutting blade elements is approximately the radial distance of the cutting edge section from the center longitudinal axis, thereby defining approximately a radius of a circle conceived around the center longitudinal axis, wherein twice the width of the cutting blade elements essentially corresponds to a diameter of the cutting device. In particular, the diameter of the cutting device is also understood as the rotation diameter.

The diameter or rotation diameter of the cutting device is determined by the diameter of a circle, which, when the cutting device rotates around the center longitudinal axis, is depicted by the free-end-side free-end edge of the cutting edge sections of the cutting blade elements. The diameter of the cutting device is thereby at a range of approximately 100 mm to 300 mm, preferably ranging from 120 mm to 280 mm, particularly preferably from 140 mm to 260 mm, being especially particularly preferred from 150 mm to 250 mm, being particularly preferred ranging from 170 mm to 230 mm, being even more preferred, ranging from 180 mm to 220 mm and, for example, at around 200 mm.

In accordance with a preferred embodiment of the invention, the width of the cutting blade elements is selected and matched to the number of cutting blade elements arranged around the center longitudinal axis in such a way that free-end edges of the cutting edge sections depict a circular line when rotated around the center longitudinal axis and the free-end edges of two adjacent cutting blade elements are spaced away from each other in such a way that a circular arc on this circular line between the free-end edges of the adjacent cutting blade elements has an arc length of a maximum of 270 mm, preferably a maximum of 200, more preferably a maximum of 170 mm and, being particularly preferred, a maximum of 150 mm.

Preferably, in the case of an even number of cutting blade elements, respectively two cutting blade elements are arranged opposite with relation to the center longitudinal axis and form an opposite pair of cutting blade elements. The connecting sections of the respective pairs adjoin one another in a flush manner and each pair forms a respective angle of around 180°.

Being particularly preferred, a pair of opposite cutting blade elements can be designed in the form of a single-piece double blade element with two free-end-sided cutting edge sections, wherein the connecting section is provided as a continuous connecting section arranged in the middle between the free-end-sided cutting edge sections.

Favourably, the holding means is shaped in the form of a blade holder by at least two profile elements, wherein each profile element is operatively connected in a holding manner to two adjacently arranged cutting blade elements. In particular, the profile elements are thereby preferably designed as angle profiles, wherein a cutting blade element is assigned to a first profile leg and wherein the first profile leg abuts or comes into contact with a first surface of the assigned cutting blade element and is connected to this. A second profile leg then attaches to a first surface of an adjacent cutting blade element and is connected to it. On the respective opposite surfaces of the cutting blade elements, other profile elements are respectively attached with one profile leg and are also connected to the cutting blade elements. Each cutting blade element is therefore received in a sandwich-like manner between two profile elements in sections and held by these.

Depending on the number of cutting blade elements arranged around the center longitudinal axis, the profile limbs of the angle profiles can, for example, form an angle of around 180° or around 120° or around 90° or approximately 72° or around 60°.

In accordance with an alternate preferred embodiment, the connecting section of the cutting blade elements is in the form of an angled flange and thus forms the holding means. The cutting blade elements can be connected to each other in such a way that each flange of a cutting blade element abuts another cutting blade element in an overlap region and there is a screw connection in the overlap region. Depending on the number of cutting blade elements distributed around the center longitudinal axis, the setting angle of the angled flange can vary. In the case of four cutting blade elements, the setting angle is around 90° for example; in the case of three cutting blade elements, it is around 120° and, in the case of six cutting blade elements, it is around 60°.

Advantages also arise in that the cutting blade elements are connected in a detachable and interchangeable manner, whereby, for example, a wear-related replacement of the cutting elements is facilitated. The detachable connection can, for example, be implemented as screw connections.

The bearing unit is preferably formed by at least two bearing elements for the supportive holding of the connected cutting blade elements, wherein the bearing elements are designed to sectionally receive the connected cutting blade elements in a supportive manner and wherein the connected cutting blade elements are at least partially received in the bearing elements in a supportive manner. Being particularly preferred, the bearing elements are orientated coaxially to the center longitudinal axis and form opposite sides of the cutting device extending across an operating width. For example, the bearing elements are in the form of correspondingly suitable bearing shafts or bearing stubs or as correspondingly suitable bearing arrangements. The bearing shafts may be approximately cone-like or cylindrical-like formed and have an engaging section for the engagement of the connected cutting blade elements as well as an axis section. Preferably, the engaging section has appropriately shaped recesses for partial receiving the connected cutting blade elements, for example, essentially slot-like recesses. The engaging section can, in particular, be designed so that a holding means designed as a blade holder together with the cutting blade elements can be received in sections in a supportive manner.

Preferably, the engaging sections of the bearing elements can be plugged or pushed on to the joined profile elements forming the blade holder by means of the formed matched recesses. In addition, the bearing elements can be firmly connected to the profile elements, for example, by means of welding or screwing. A safeguard by means of splints is also conceivable.

The bearing elements are preferably designed and set up so that the cutting device can be mounted in a carrier frame of a soil tillage device, so that the center longitudinal axis of the cutting device runs essentially perpendicular or at an acute angle to an operating direction of the soil tillage device.

With an above described, preferred embodiment of the bearing unit, the cutting device can be mounted or suspended, for example, in a carrier frame, preferably in a carrier frame of a soil tillage device. Thus, it is possible to align the cutting device by means of the suitable mounting or suspension in the carrier frame of the soil tillage device in such a way that the center longitudinal axis is orientated transversely to the operating direction and essentially runs perpendicularly to the operating direction. Similarly however, it is possible, by means of appropriate mounting or suspension, and it is preferred in accordance with alternative embodiments to align the cutting device in such a way that the center longitudinal axis runs at an acute angle to the operating direction, for example at an angle between 90° and 50°, preferably at an angle of 80° to 60° and, being particularly preferred, at an angle of about 70°.

Being particularly favorable, by means of suitable mounting or suspension in the carrier frame, the cutting device can be operated in a so-called push mode, namely in front of the tractor unit in the operating direction, or, as an alternative, in a so-called pull mode, namely, after the tractor unit in the operating direction. In this way, the cutting device can be operated use-oriented and according to desired requirements. For example, the operating mode, the working speed, and the energy expenditure for the operation can thereby be adapted in a desired manner.

The cutting device can be composed of a plurality of cutting units, wherein the cutting units adjoin one another in the direction of the center longitudinal axis and are orientated coaxially to each other and are connected to each other by means of a connection unit. In accordance with these preferred embodiments, the cutting device is virtually modular, wherein at least one first cutting unit extends across a first partial operating width and a second cutting unit extends over a second partial operating width. Together, the cutting units cover the entire operating width of the cutting device. The cutting units are preferably designed to be identical in construction, wherein each cutting unit essentially forms a stand-alone cutting device in accordance with the above description. Thereby, it is conceivable that the bearing units also assume the function of the connection units and vice versa.

Special advantages arise in embodiments with a plurality of cutting units if the cutting units are orientated relative to each other in such a way that the cutting blade elements of directly successive cutting units are offset to each other in relation to the circumference around the center longitudinal axis since, due to this, the rotation, in particular the revolution of the cutting device, is smoother, more uniform and quieter. At great operating widths and, in particular, in cases where very few cutting blade elements are provided, unbalances may arise when the cutting device rotates. Due to the offset of the cutting units or due to the offset arrangement of the cutting blade elements in the circumferential direction, these imbalances can be effectively prevented.

Being particularly preferred, a plurality of cutting devices can be used in a carrier frame of a soil tillage unit by means of a corresponding mounting and suspension, as described above. It is to be understood that, for example, a tandem operation with two cutting devices successively connected in the operating direction of the soil tillage unit and arranged essentially in parallel to each other is possible. Also, three or four or a plurality of cutting devices in the operating direction of the soil tillage unit can be successively connected. The plurality of cutting devices can be aligned in such a way that the respective center longitudinal axes run essentially perpendicular to the operating direction or at an acute angle to the operating direction. Being particularly preferred, when a plurality of cutting devices successively connected in the operating direction in a carrier frame is used, rotational diameters of the cutting devices can vary, wherein cutting devices are combined with different diameters or rotation diameters.

Favorably, the cutting device can be used in a soil tillage device and can be combined with other soil tillage tools. For example, the cutting device can be upstream from a cultivator.

It is an object of the invention also to provide a soil cultivation device with at least one cutting device as described above, which is rotatably mounted in a carrier frame of the soil cultivation device.

### BRIEF DESCRIPTION OF THE DRAWINGS

The invention will be explained in more detail in the following based on the exemplary embodiments in connection with the drawings. The figures show:

FIG. 1 a preferred embodiment of the cutting device according to the present invention in a perspective view;

FIG. 2 in part, a lateral end region of the embodiment of FIG. 1 in perspective view;

FIG. 3 in a schematic sectional view a cross-section of the embodiment of FIGS. 1 and 2 along the cutting line A-A,

FIG. 4a-4c in a schematic sectional view, cross-sections of other embodiments of the cutting device and

FIG. 5 in part, an alternative embodiment of the cutting device according to the present invention in a perspective view.

### DETAILED DESCRIPTION OF THE INVENTION

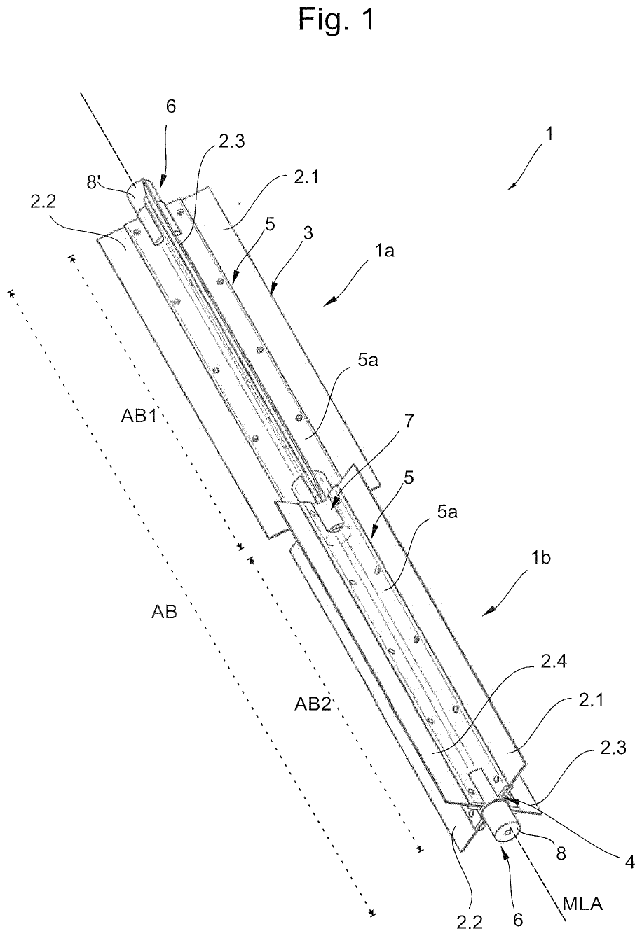

FIG. 1 shows a perspective view of a preferred embodiment of the cutting device 1 according to the invention. The cutting device 1 shown as an example is composed of two structurally identical cutting units 1a, 1b that are successively arranged along a center longitudinal axis MLA and are connected to each other by means of a connection unit 7, wherein the first cutting unit 1a extends across a first partial operating width AB1 and the second cutting unit 1b extends across a second partial operating width AB2. The cutting device 1 therefore covers a total operating width AB, wherein the operating width AB runs essentially perpendicular to an operating direction, which can also be seen as a feed direction of the cutting device 1 in operational use.

It is to be understood that the present cutting device 1 can be constructed just as well out of only one cutting unit, and each of the illustrated structurally identical cutting units 1a, 1b can form an independent cutting device 1 on its own.

The cutting device 1 designed, in particular, in order to comminute crop residues or catch crops on agricultural land is designed to be rotatable around the center longitudinal axis MLA and can also be understood as a cutting roller arrangement or blade roller arrangement. Thereby, the center longitudinal axis MLA simultaneously represents an axis of rotation of the cutting device 1, around which the cutting device 1 rotates during operation.

The cutting device 1 can be used as a corresponding cutting tool in a soil tillage device or in a soil tillage unit. For example, the cutting device 1 can be operated individually in “solo mode” or also in combination with another soil tillage tool, for example, with a cultivator or with a disc harrow or the like. The cutting device 1 can be additionally mounted in a carrier frame, in particular, together with the soil tillage tool(s). In particular, the cutting device 1 is suitable for operation in a so-called push mode, namely in the operating direction before the tractor unit or alternatively in a so-called pull mode, namely, to be operated in the operating direction after the tractor unit.

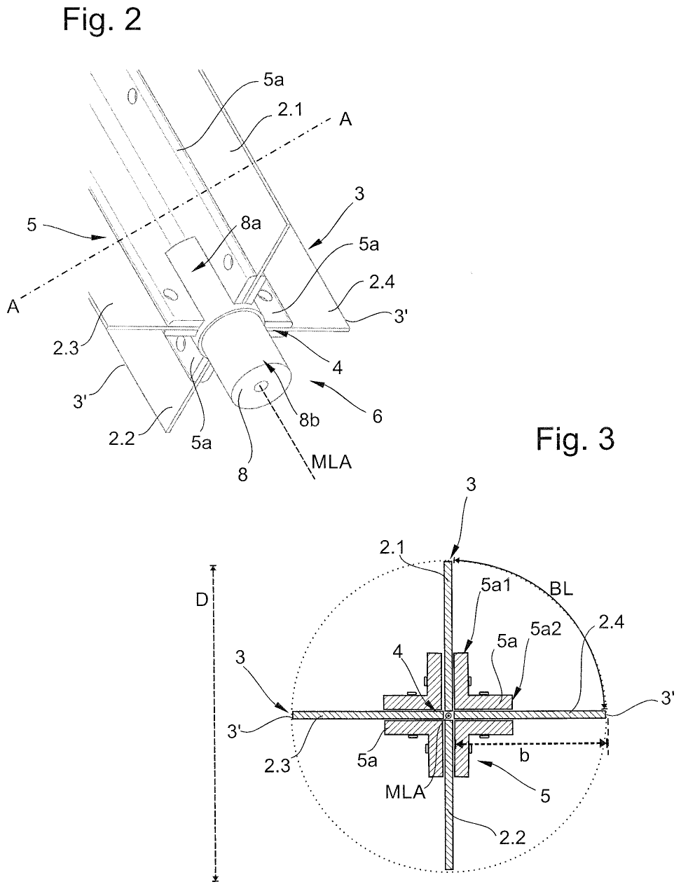

For a corresponding mounting or suspension in a carrier frame, for example in a carrier frame of a soil tillage unit, the cutting device 1 has at least one bearing unit 6 for rotatably mounting. The bearing unit 6 in the illustrated example comprises two bearing elements 8, 8′, which are orientated coaxially to the center longitudinal axis MLA and are arranged relative to the operating width AB on opposite outer sides of the cutting device 1. The embodiment of the bearing elements 8, 8′ is to be discussed in more detail in connection with FIG. 2.

The cutting device 1—in the example shown, each of the structurally identical cutting units 1a, 1b—comprises a first and second respectively elongated cutting blade element 2.1, 2.2, as well as two further elongated cutting blade elements 2.3, 2.4 and at least one holding means 5 designed in the form of a blade holder for holding the cutting blade elements 2.1-2.4. Each cutting blade element 2.1-2.4 is essentially designed as a rectangular flat material piece and respectively has a cutting edge section 3 on a longitudinal side and a connecting section 3 opposite to the cutting edge section 4 on the opposite longitudinal side.

The elongated flat cutting blade elements 2.1-2.4 are radially orientated, and that being with reference to the center longitudinal axis MLA or based on the center longitudinal axis MLA. The cutting edge sections 3 are arranged at a radial distance from the center longitudinal axis MLA. The cutting blade elements 2.1, 2.2 are directly connected to each other with the aid of the blade holder 5, wherein the connecting sections 4 of the cutting blade elements 2.1-2.4 are arranged adjoining one another in a center region of the cutting device 1 receiving the center longitudinal axis MLA. The cutting device 1 is therefore to be understood as a shaftless blade roller arrangement, and that being as a blade roller arrangement without a cylindrical roller body.

The cutting blade elements 2.1-2.4 of the example shown are arranged essentially crosswise, wherein the first and second cutting blade element 2.1, 2.2 are lying opposite relative to the center longitudinal axis MLA and form an opposite pair, and wherein the further cutting blade elements 2.3, 2.4 are also lying opposite relative to the center longitudinal axis MLA and form another opposite pair, as is particularly also evident from FIG. 3, which shows a cross-section along the cut line A-A (see FIG. 2) in a schematic sectional view by means of the embodiment in FIG. 1.

In order to achieve a quieter, more uniform rotation of the cutting device 1 during the operation and to avoid imbalances, in the preferred embodiment of FIG. 1, the cutting units 1a, 1b are aligned relative to each other in such a way that the cutting blade elements 2.1-2.4 of the successive cutting units 1a, 1b are offset to each other in relation to the circumference around the center longitudinal axis MLA. The cutting blade elements 2.1-2.4 of the second cutting unit 1b are, with reference to circumference, virtually disposed on spacings in the cutting blade elements 2.1-2.4 of the first cutting unit 1b and vice versa.

In detail, the arrangement and connection of the cutting blade elements 2.1-2.4 is now explained with reference to FIG. 3. The cutting blade elements 2.1-2.4 are regularly distributed around the center longitudinal axis MLA, so that adjacent cutting blade elements 2.1-2.4 each have an angular distance of 90° to each other. In other words, adjacent cutting blade elements 2.1-2.4 each form an angle of about 90°.

The respective connecting sections 4 of the cutting blade elements 2.1-2.4 are thereby directly connected to each other with the aid of the blade holder 5 in the central region and directly adjoin at a right angle. The blade holder 5 in the example shown comprises four profile elements 5a, which are designed in the form of angle profiles, in particular, L-profiles. The four cutting blade elements 2.1-2.4 in the example shown are thereby held by four profile elements 5a and directly connected to each other by means of these.

Each profile element 5a comprises a first and second profile leg 5a1, 5a2, which form a right angle in the example in FIG. 3. Each profile element 5a is operatively connected to respectively two adjacently arranged cutting blade elements 2.1-2.4, wherein the profile legs 5a1, 5a2 each abut a surface of the cutting blade elements 2.1-2.4 in the region of the connecting section 4 and are connected to these. In order to supportively mount the cutting blade elements 2.1-2.4, two profile elements 5a engage with each cutting blade element 2.1-2.4, and that being on opposite surfaces of the cutting blade elements 2.1-2.4. Each cutting blade element 2.1-2.4 is therefore arranged in a sandwich-like manner between two profile elements 5a, in particular, arranged between profile legs of the two profile elements 5a and connected to the profile elements 5a in this way.

The connecting sections 4 of the cutting blade elements 2.1-2.4 are thereby directly connected to each other and each of them directly adjoin one another at a right angle. A width b of the cutting blade elements 2.1-2.4 approximately defines a radius of a circle conceived around the center longitudinal axis, which the free-sided free-end edges 3′ of the cutting edge sections 3 of the cutting blade elements 2.1-2.4 depicts while the cutting device 1 rotates around the center longitudinal axis MLA. Thus, twice the width b of the cutting blade elements 2.1-2.4 essentially corresponds to a diameter D of the cutting device 1.

The width of the cutting blade elements 2.1-2.4 is selected in such a way that the free-end edges 3′ of the cutting edge sections 3 of two adjacent cutting blade elements 2.1-2.4 are spaced away from each other in such a way that a circular arc between the free-end edges of the adjacent cutting blade elements has an arc length BL of a maximum of 170 mm. This arc length BL specifies the cutting length in operational mode of the cutting device 1, by means of which the plant parts or crop residues, in particular stubbles or stalks, are comminuted. The arc length of an arc is calculated according to the formula to be applied using the product of radius and center point angle (indicated in the radian measure). The width b of the cutting blade elements 2.1-2.4 can thus be optimally selected depending on the number of cutting blade elements 2.1-2.4 arranged around the center longitudinal axis MLA in such a way that the arc length BL between the cutting edge sections 3—and thus the cutting length of the cutting device 1—is not greater than 170 mm, preferably not greater than 150 mm. In the case of four cutting blade elements 2.1-2.4, each being adjacent to each other at right angle, the width b is around 90 mm to 100 mm for example.

Particularly favourably, in particular, a small number of cutting blade elements 2.1-2.4 can be used with the present cutting device 1 and therefore large angular distances between the cutting blade elements 2.1-2.4 can be kept to in order to achieve short cutting lengths of less than 170 mm nevertheless, preferably less than 150 mm for plant parts or crop residues to be comminuted. Due to this, even in the case of the desired or required short cutting length, a clogging of the cutting device 1 with plant residues and soil can be effectively countered and this can be reduced to a minimum. By means of this, the cutting performance and, in particular, the cutting quality of the cutting device 1 is significantly improved.

The large angular distances between the cutting blade elements 2.1-2.4, which can also be understood as wide opening angles between the cutting blade elements 2.1-2.4, are possible due to the smaller diameter D of the cutting device 1, which is only about twice the width b of the cutting blade elements 2.1-2.4. Compared to conventional blade rollers, the diameter of the present cutting device 1 is significantly smaller, since in the case of the known blade rollers from the prior art, the diameter is calculated by adding the diameter of the roller body or of the hollow shaft or of the hollow shaft and twice the width of blades or cutting blade elements attached to them.

Favorably, with the present cutting device 1, angular distances or opening angles of significantly more than 60° or 90° can be adhered to and nevertheless short cutting lengths can be achieved.

With reference to FIG. 2, the embodiment of the bearing unit 6 made of two bearing elements 8, 8′ is now described more in detail. Each bearing element 8, 8′ of the bearing unit 6 used for the supportive holding of the connected cutting blade elements 2.1 to 2.4 is orientated coaxially to the center longitudinal axis MLA and is designed for receiving the connected cutting blade elements 2.1 to 2.4 in sections in a supportive manner, in particular, for receiving of the blade holder 5 in sections connected to the cutting blade elements 2.1 to 2.4 and holding these. The bearing elements 8, 8′ are preferably in the form of correspondingly suitable bearing shafts or bearing stubs.

In the illustrated example in FIG. 2, in which the blade holder comprises 5 four profile elements 5a, in particular, four angle profiles, the profile elements 5a connected to the cutting blade elements 2.1 to 2.4 are partially received in the bearing elements 8, 8′ in a supportive manner. The bearing elements 8, 8′ have an engaging section 8a for engaging the blade holder as well as an axis section 8b for rotatably mounting in a carrier frame. The engaging section 8a has correspondingly shaped recesses, in which the profile legs Sa1, 5a2 of the profile elements 5a together with the cutting blade elements 2.1-2.4 arranged in between in a sandwich-like manner are partially received. The engaging sections 8a of the bearing elements 8, 8′ can be plugged or pushed onto the joined profile elements 5a connected to the cutting blade elements 2.1-2.4 by means of the formed matched recesses. In addition, the bearing elements 8, 8′ can be firmly connected to the profile elements 5a, for example, by means of welding or screwing. A safeguard by means of splints is also conceivable.

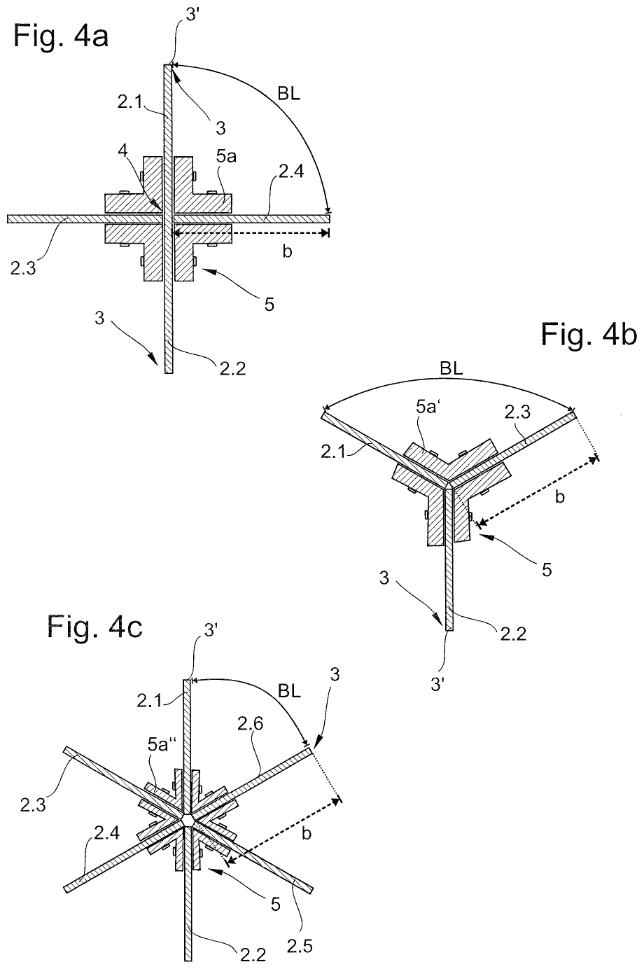

In FIGS. 4a, 4b and 4c, other preferred embodiments of the cutting device 1 are shown. The embodiment in accordance with FIG. 4a essentially differs from the one in FIGS. 1 to 3 only in that the first and second cutting blade elements 2.1, 2.2 are shaped in the form of a single-piece double blade element, which has two cutting edge sections 3, which are arranged at both ends on the free-end side. The connecting section 4 is formed as a continuous section, which lies in the middle between the two cutting edge sections 3.

In the embodiment in accordance with FIG. 4b, three cutting blade elements 2.1, 2.2, 2.3 are provided, wherein the adjacent cutting blade elements 2.1, 2.2, 2.3 each form an angle of approximately 120° and the respective connecting sections 4 connect to each other at this very angle. For the supportive mounting and connection of the three cutting blade elements 2.1, 2.2, 2.3, three profile elements 5a′ designed as angle profiles are provided, whose profile legs form an angle of about 120°. In the case of this preferred embodiment, the width b of the cutting blade elements 2.1, 2.2, 2.3 is at approximately 70 mm to 80 mm so that the arc length BL here, in turn, is also not greater than 170 mm, preferably not greater than 150 mm and the short cutting length is adhered to.

In the embodiment in accordance with FIG. 4c, six cutting blade elements 2.1-2.6 are provided, wherein the adjacent cutting blade elements 2.1-2.6 each form an angle of around 60° and the respective connecting sections 4 connect to each other at this very angle. For the supportive mounting and connection of the six cutting blade elements 2.1-2.6, six profile elements 5a″ designed as angle profiles are provided, whose profile legs form an angle of about 60°. In the case of this preferred embodiment, the width b of the cutting blade elements 2.1-2.6 is at approximately 140 mm to 160 mm so that the arc length BL here, in turn, is also not greater than 170 mm, preferably not greater than 150 mm and the short cutting length is adhered to.

Although not shown in the figures, another preferred embodiment comprises only two cutting blade elements 2.1, 2.2 lying opposite to each other with respect to the center longitudinal axis MLA, which are connected to each other by means of two profile elements each designed as a straight rail profile. In this embodiment, the cutting blade elements 2.1, 2.2 have a width b of about 55 mm so that here, in turn, the arc length BL is also not greater than 170 mm and the short cutting length is adhered to.

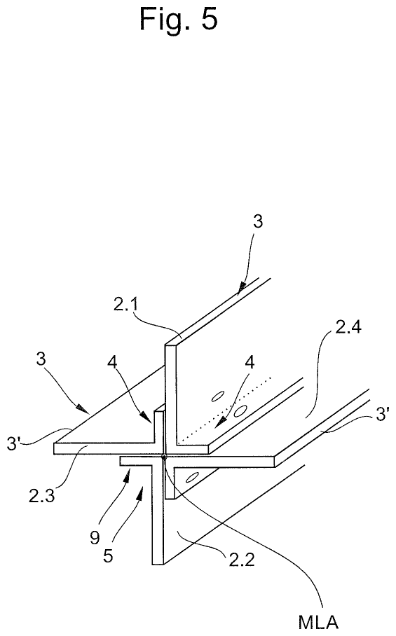

FIG. 5 shows in part a perspective view of an alternative preferred embodiment of the cutting device 1. In this embodiment, the connecting section 4 of the cutting blade elements 2.1-2.4 is in the form of an angled flange and thus forms the holding means 5. The cutting blade elements 2.1-2.4 are connected to each other in such a way that each flange of a cutting blade element 2.1-2.4 abuts another cutting blade element 2.1-2.4 in an overlap region 9 and there is a screw connection in the overlap region 9. Depending on the number of the cutting blade elements 2.1-2.4 distributed around the center longitudinal axis MLA, the setting angle of the angled flange can vary. In the case of four cutting blade elements 2.1-2.4 like in the example shown, the setting angle is around 90° for example.

### REFERENCE LIST

1 cutting device
1a, 1b cutting units
2.1 first cutting blade element
2.2 second cutting blade element
2.3-2.6 other cutting blade elements
3 cutting edge section
3′ free-end edge
4 connecting section
5 holding means
5a, 5a′, 5a″ profile element
6 bearing unit
7 connection unit
8, 8′ bearing element
8a bearing section
8b engaging section
9 overlap region
AB operating width
AB1, AB2 first and second partial operating width
B width
BL arc length
D diameter
MLA center longitudinal axis

What is claimed is:

1. A cutting device for comminuting crop residues, catch crop stocks or catch crops on agricultural land, wherein the cutting device is rotatable around a center longitudinal axis (MLA) having at least one bearing unit for rotatably mounting, wherein the cutting device comprises:
first and second elongated cutting blade elements,
at least one holding means for holding the elongated cutting blade elements, the elongated cutting blade elements each having a cutting edge section and connecting sections opposite the cutting edge section that are radially orientated and the cutting edge section is arranged at a radial distance from the center longitudinal axis (MLA), wherein the elongated cutting blade elements are directly connected to each other by the at least one holding means, and wherein the connecting sections of the elongated cutting blade elements are arranged directly adjoining one another in a center region of the cutting device receiving the center longitudinal axis (MLA).

2. The cutting device according to claim 1, wherein a plurality of elongated cutting blade elements are provided, wherein the plurality of elongated cutting blade elements are directly connected to each other in such a way that respective connecting sections of the plurality of elongated cutting blade elements directly adjoin one another in the center region.

3. The cutting device according to claim 2, wherein the plurality elongated cutting blade elements are arranged in a regularly distributed manner around the center longitudinal axis (MLA) in such a way that angular distances between adjacent cutting blade elements are respectively the same.

4. The cutting device according to claim 1, wherein a width (b) of the elongated cutting blade elements extending in a radial direction ranges from 50 mm to 150 mm, wherein the width (b) of the elongated cutting blade elements approximately defines a radius of a circle conceived around the center longitudinal axis (MLA) and wherein twice the width (b) of the elongated cutting blade elements essentially corresponds to a diameter (D) of the cutting device.

5. The cutting device according to claim 4, wherein the width (b) of the elongated cutting blade elements is matched to a number of elongated cutting blade elements arranged around the center longitudinal axis (MLA) so that free-end edges of the cutting edge sections depict a circular line during rotation around the center longitudinal axis (MLA) and the free-end edges of two adjacent elongated cutting blade elements are spaced away from each other in such a way that a circular arc between the free-end edges of the adjacent elongated cutting blade elements have an arc length (BL) of a maximum of 270 mm.

6. The cutting device according to claim 1, wherein when an even number of elongated cutting blade elements are used, two elongated cutting blade elements are respectively arranged opposite in relation to the center longitudinal axis (MLA) and form an opposite pair of elongated cutting blade elements, wherein the connecting sections of the respective pairs of elongated cutting blade elements connect each other in a flush manner and each pair of elongated cutting blade elements forms a respective angle of about 180°.

7. The cutting device according to claim 6, wherein a pair of opposite elongated cutting blade elements is a single-piece double blade element with two free-end-sided elongated cutting edge sections, wherein the connecting section is provided as a continuous connecting section arranged in a middle between the two free-end-sided cutting edge sections.

8. The cutting device according to claim 1, wherein the holding means is a blade holder with at least two profile elements, wherein each profile element is operatively connected to two adjacently arranged elongated cutting blade elements.

9. The cutting device according to claim 8, wherein the profile elements are angle profiles.

10. The cutting device according to claim 1, wherein the connecting section of the elongated cutting blade elements are angled flanges and form the holding means.

11. The cutting device according to claim 1, wherein the elongated cutting blade elements are connected in a detachable and interchangeable manner.

12. The cutting device according to claim 1, wherein the bearing unit is formed by at least two bearing elements for supportive holding of connected elongated cutting blade elements, wherein the bearing elements are designed for supportive, sectional receiving of the connected elongated cutting blade elements and the connected elongated cutting blade elements are at least in sections received in a supportive manner in the bearing elements.

13. The cutting device according to claim 12, wherein the bearing elements are coaxially orientated to the center longitudinal axis (MLA) and define opposite outer sides of the cutting device extending across an operating width (AB) and/or that the cutting device can be used in a soil cultivation device and can be combined with other soil cultivation tools.

14. The cutting device according to claim 1, wherein the cutting device is composed of a plurality of cutting units, wherein the cutting units adjoin one another in the direction of the center longitudinal axis (MLA) and are orientated coaxially to each other and are connected to each other by a connection unit, wherein the cutting units are aligned relative to one another in such a way that the elongated cutting blade elements of directly successive elongated cutting blade elements are offset to each other or aligned to be flush with one another.

15. A soil cultivation device with at least one cutting device comprising a center longitudinal axis (MLA) for comminuting crop residues or catch crops on agricultural land, wherein the at least one cutting device is mounted in a carrier frame of the soil cultivation device via at least one bearing unit in a manner to be rotatable around the center longitudinal axis (MLA),
wherein the at least one cutting device comprises:
first and second elongated cutting blade elements,
at least one holding means for holding the elongated cutting blade elements, wherein the elongated cutting blade elements each have a cutting edge section and a connecting section opposite from the cutting edge section is radially orientated and the cutting edge section is arranged at a radial distance from the center longitudinal axis (MLA), wherein the elongated cutting blade elements are directly connected to each other with holding means, wherein the connecting sections of the elongated cutting blade elements are arranged directly adjoining one another in a center region of the at least one cutting device receiving the center longitudinal axis (MLA).
